(19) United States
(12) Patent Application Publication
(10) Pub. No.: US 2017/0093705 A1
(43) Pub. Date: Mar. 30, 2017

(54) SYSTEMS AND METHODS FOR LATENCY BASED ROUTING

(71) Applicant: Infinera Corporation, Annapolis Junction, MD (US)

(72) Inventors: Abishek GOPALAN, San Jose, CA (US); Biao LU, Sunnyvale, CA (US); Rajan RAO, Fremont, CA (US)

(21) Appl. No.: 14/986,514

(22) Filed: Dec. 31, 2015

Related U.S. Application Data
(60) Provisional application No. 62/233,387, filed on Sep. 27, 2015.

(51) Int. Cl. H04L 12/721; H04L 12/26; H04L 12/727; H04L 12/751

(52) U.S. Cl. CPC H04L 45/70; H04L 45/02; H04L 43/0852; H04L 45/121; H04L 45/62

(57) ABSTRACT

A method for determining a path through a communication network may include determining a first and second path from a first device to a second device based on path latency, removing from further consideration the first or the second path based on which has the highest path latency of the first and second path, and determining path candidates until a path candidate is found with the lowest differential latency between the determined first or second path and the path candidate.

### CLAIM OF PRIORITY

The present Application for Patent claims priority to Provisional Application No. 62/233,387 entitled “Latency Based Routing” filed Sep. 27, 2015, and assigned to the assignee hereof and hereby expressly incorporated by reference herein.

### FIELD OF DISCLOSURE

This disclosure relates generally to communication networks and more specifically, but not exclusively, to routing for a communication network.

### BACKGROUND

Conventional communication networks, such as optical communication networks, are composed of a series of switches or routers called nodes or network elements interconnected by transmission mediums called links or paths (e.g. optical fibers) that allow the transmission of data between the nodes. Traffic Engineering (TE) is a technology that is concerned with performance optimization of communication networks. In general, Traffic Engineering includes a set of applications, mechanisms, tools, and scientific principles that allow for measuring, modeling, characterizing and controlling data traffic within the network in order to achieve specific performance objectives of the network. Data traffic signifies data exchanged between two nodes, such as an originating node (e.g. a source node) and a terminating node (e.g. a destination or sink node). Within the network, data traffic can be transported between any two locations using predefined connections specifying particular links and/or switch nodes for conveying the data traffic.

The switch nodes in the network are each provided with a control module. The control modules of the switch nodes function together to aid in the control and management of the switched networks. The control modules can run a variety of protocols for conducting the control and management of the switched networks. One prominent protocol is referred to in the art as “Generalized Multiprotocol Label Switching (GMPLS)”.

Generalized Multiprotocol Label Switching (GMPLS) is a type of protocol which extends multiprotocol label switching to encompass network schemes based upon time-division multiplexing (e.g. SONET/SDH, PDH, G.709), wavelength multiplexing, and spatial switching (e.g. incoming port or fiber to outgoing port or fiber). Multiplexing, such as time-division multiplexing is when two or more signals or bit streams are transferred over a common channel.

Generalized Multiprotocol Label Switching includes multiple types of label switched paths including protection and recovery mechanisms which specifies predefined (1) working connections within a network having multiple nodes and communication links for transmitting data between a source node and a destination node; and (2) protecting connections specifying a different group of nodes and/or communication links for transmitting data from the source node to the destination node in the event that one or more of the working connections fail. Working connections may also be referred to as working paths. Protecting connections may also be referred to as protecting paths and/or protection paths. A first node of a path may be referred to as a source node. A last node of a path may be referred to as an end node or destination node. Data is initially transmitted over the working connection (such as an optical channel data unit label switched path) and then, when a working connection fails, the source node or end node activates one of the protecting connections for redirecting data within the network.

The set up and activation of the protecting connections may be referred to as restoration or shared protection. For example, Shared Mesh Protection (SMP) is a common protection and recovery mechanism in transport networks where multiple paths can share the same set of network resources for protection purposes. Resources such as nodes and communication links in protecting connections are typically shared by multiple working connections that are not affected by the same failure, thus increasing efficient use of network resources.

However, current systems inefficiently utilize the provisioned capacity of a network when determining protecting connections, especially for large-scale networks. For example, the working path may not be divided into the optimal segments, where optimal segment choice would provide the least costly alternate path through the network in case of failure in the working path. Systems and methods are needed to determine preferred segments of the working path for segment protection based on the network condition and topology, and for implementation of such protection, in order to optimize network capacity and knowledge of failure locations.

Accordingly, there is a need for systems, apparatus, and methods that improve upon conventional approaches including the improved methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method for communication includes: retrieving information of a topology of the communication network, the information including a plurality of connections between each of a plurality of devices in the communication network and latency information of each connection of the plurality of connections; determining a first path from a first device of the plurality of devices to a second device of the plurality of devices, the first path including a first portion of the plurality of connections with a lowest total latency between the first device and the second device; determining a second path from the first device to the second device, the second path including a second portion of the plurality of connections with a second lowest total latency between the first device and the second device; selecting the second path as one of a work path or a protect path; removing the second portion of the plurality of connections from the second path from the information of the topology of the communication network; determining a third path from the first device to the second device, the third path including a third portion of the plurality of connections with a third total latency between the first device and the second device; determining a fourth path from the first device to the second device, the fourth path including a fourth portion of the plurality of connections with a fourth total latency between the first device and the second device; determining a first latency differential between the third total latency and the second lowest total latency; determining a second latency differential between the fourth total latency and the second lowest total latency; selecting the third path as one of the work path or the protect path if the first latency differential is less than the second latency differential; and selecting the fourth path as one of the work path or the protect path if the first latency differential is greater than the second latency differential.

In another aspect, an apparatus includes: means for retrieving information of a topology of the communication network, the information including a plurality of connections between each of a plurality of devices in the communication network and latency information of each connection of the plurality of connections; means for determining a first path from a first device of the plurality of devices to a second device of the plurality of devices, the first path including a first portion of the plurality of connections with a lowest total latency between the first device and the second device; means for determining a second path from the first device to the second device, the second path including a second portion of the plurality of connections with a second lowest total latency between the first device and the second device; means for selecting the second path as one of a work path or a protect path; means for removing the second portion of the plurality of connections from the second path from the information of the topology of the communication network; means for determining a third path from the first device to the second device, the third path including a third portion of the plurality of connections with a third total latency between the first device and the second device; means for determining a fourth path from the first device to the second device, the fourth path including a fourth portion of the plurality of connections with a fourth total latency between the first device and the second device; means for determining a first latency differential between the third total latency and the second lowest total latency; means for determining a second latency differential between the fourth total latency and the second lowest total latency; means for selecting the third path as one of the work path or the protect path if the first latency differential is less than the second latency differential; and means for selecting the fourth path as one of the work path or the protect path if the first latency differential is greater than the second latency differential.

In still another aspect, a non-transient computer readable medium containing program instructions for causing a processor to perform a process including: retrieving information of a topology of the communication network, the information including a plurality of connections between each of a plurality of devices in the communication network and latency information of each connection of the plurality of connections; determining a first path from a first device of the plurality of devices to a second device of the plurality of devices, the first path including a first portion of the plurality of connections with a lowest total latency between the first device and the second device; determining a second path from the first device to the second device, the second path including a second portion of the plurality of connections with a second lowest total latency between the first device and the second device; selecting the second path as one of a work path or a protect path; removing the second portion of the plurality of connections from the second path from the information of the topology of the communication network; determining a third path from the first device to the second device, the third path including a third portion of the plurality of connections with a third total latency between the first device and the second device; determining a fourth path from the first device to the second device, the fourth path including a fourth portion of the plurality of connections with a fourth total latency between the first device and the second device; determining a first latency differential between the third total latency and the second lowest total latency; determining a second latency differential between the fourth total latency and the second lowest total latency; selecting the third path as one of the work path or the protect path if the first latency differential is less than the second latency differential; and selecting the fourth path as one of the work path or the protect path if the first latency differential is greater than the second latency differential.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIGS. 1A and 1B illustrate an exemplary communication method for latency based routing using a baseline approach in accordance with some examples of the disclosure.

FIGS. 1C and 1D illustrate an exemplary communication method for latency based routing using a baseline approach in accordance with some examples of the disclosure.

FIGS. 2A and 2B illustrate an exemplary communication method for latency based routing using a least latency approach in accordance with some examples of the disclosure.

FIGS. 3A-D illustrate an exemplary communication method for latency based routing using a shortest path solution pair approach in accordance with some examples of the disclosure.

FIG. 4 illustrates an exemplary communication method for latency based routing using a baseline approach in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein advantageously address the industry needs, as well as other previously unidentified needs, and mitigate shortcomings of the conventional methods, apparatus, and systems. For example, a pair of disjointed or unrelated paths through a network may be determined using two paths with the least differential latency between each of the two paths instead of choosing a path with the least latency and then determining a path with the second least latency. This may be accomplished by selecting the second least latency path and removing this path from the possible paths considered. Then compute the latency for all remaining paths until one with the same latency as the removed path is found or the one with the smallest difference in latency is found. These two paths will form the new working and protection paths for this pair with the path having the lowest latency of the two being selected as the working path and the other as the protection path. In certain applications, the latency between the work and protect paths is more important than the absolute latency of the work path, for example. Such applications may include a voice communication session or video streaming type application along with other types where the latency between the work and protect path is important.

Wavelength division multiplexed (WDM) optical communication systems (referred to as “WDM systems”) are systems in which multiple optical signals, each having a different wavelength, are combined onto a single optical fiber using an optical multiplexer circuit (referred to as a “multiplexer”). Such systems may include a transmitter circuit, such as a transmitter (Tx) PIC having a transmitter component to provide a laser associated with each wavelength, a modulator configured to modulate the output of the laser, and multiplexer to combine each of the modulated outputs (e.g., to form a combined output).

A PIC is a device that integrates multiple photonic functions on a single integrated device. PICs may be fabricated in a manner similar to electronic integrated circuits but, depending on the type of PIC, may be fabricated using one or more of a variety of types of materials, including silica on silicon, silicon on insulator, and various polymers and semiconductor materials which are used to make semiconductor lasers, such as GaAs, InP and their alloys.

A WDM system may also include a receiver circuit having a receiver (Rx) PIC and an optical demultiplexer circuit (referred to as a “demultiplexer”) configured to receive the combined output and demultiplex the combined output into individual optical signals. Additionally, the receiver circuit may include receiver components to convert the optical signals into electrical signals, and output the data carried by those electrical signals.

The transmitter (Tx) and receiver (Rx) PICs, in an optical communication system, may support communications over a number of wavelength channels. For example, a pair of Tx/Rx PICs may support ten channels, each spaced by, for example, 50 GHz. The set of channels supported by the Tx and Rx PICs can be referred to as the channel “grid” for the PICs. Channel grids for Tx/Rx PICs may be aligned to standardized frequencies, such as those published by the Telecommunication Standardization Sector (ITU-T). The set of channels supported by the Tx and Rx PICs may be referred to as the ITU frequency grid for the Tx/Rx PICs.

In WDM systems, the demultiplexer may be capable of receiving first and second optical signals associated with the combined output in order to increase data rates associated with the WDM system. In order to further increase the data rates associated with a WDM system, additional WDM components are sometimes incorporated. For example, some WDM systems may include a polarization beam splitter (PBS) to receive the combined output and output first and second optical signals, to increase the data rates associated with the WDM system. The first optical signal may include components having a first polarization and the second optical signal may include components having a second polarization. Some WDM systems may further include a rotator to rotate the polarization of the components associated with the first optical signal such that the components have the second polarization, thereby allowing the demultiplexer to process optical signals associated with one polarization (e.g., the second polarization).

WDM systems are sometimes constructed from discrete components (e.g., a transmitter component, a multiplexer, a demultiplexer, a PBS, a rotator, and/or a receiver component). For example, demultiplexers and receiver components may be packaged separately and provided on a printed circuit board. Alternatively, WDM components are sometimes integrated onto a single chip, also referred to as a photonic integrated circuit (PIC). For example, a PBS and a rotator are provided on the same PIC as a demultiplexer.

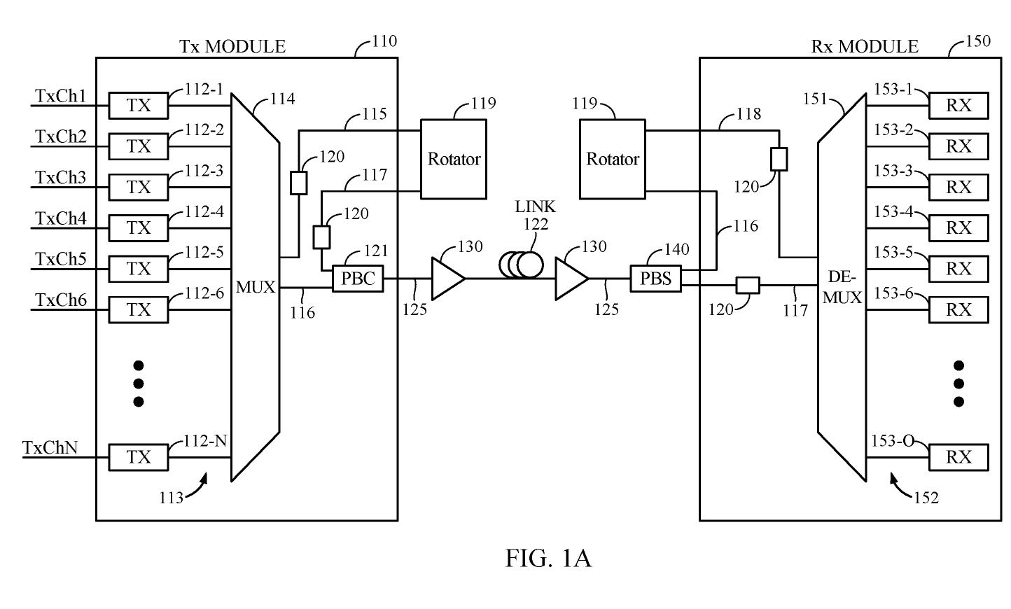

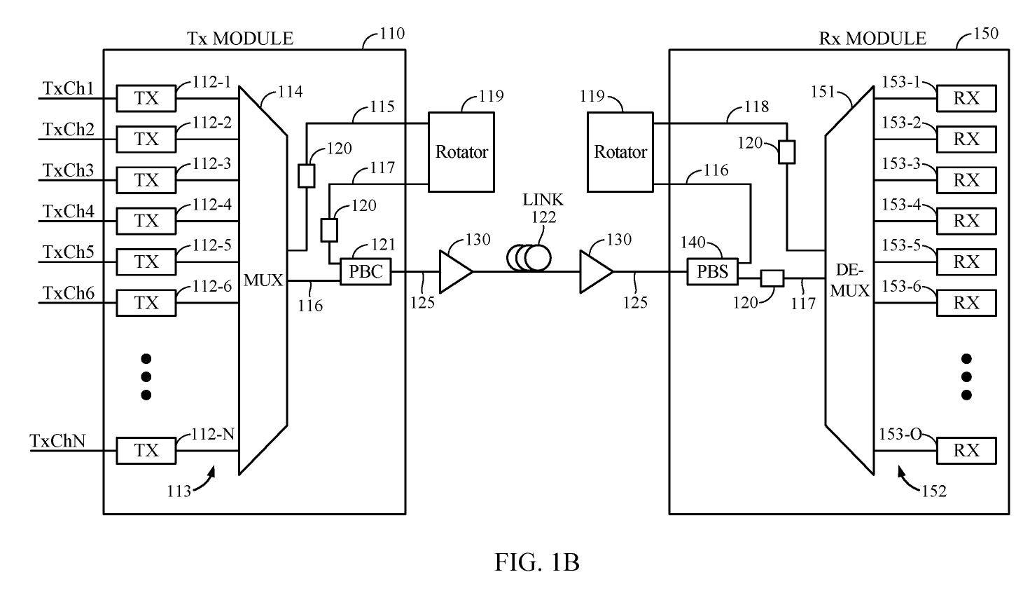

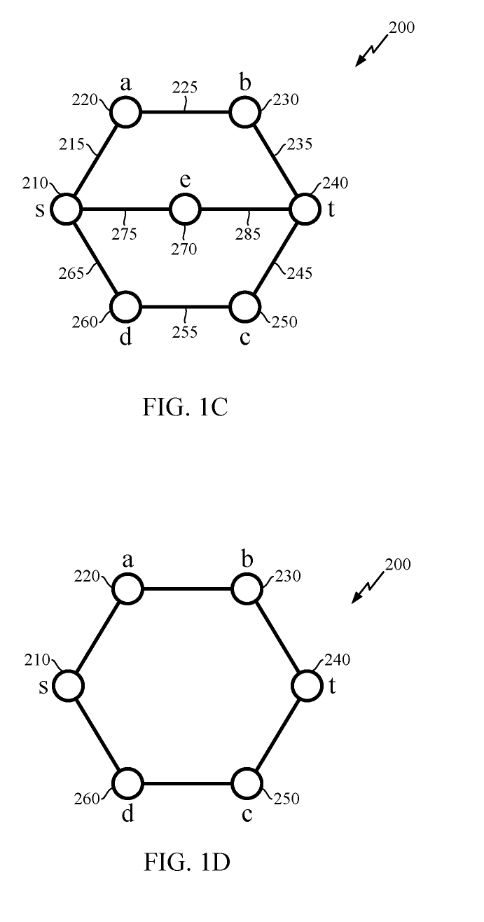

FIGS. 1A and 1B illustrate an exemplary PIC of a network element 100 in accordance with some examples of the disclosure. It should be understood that network element 100 may include additional, fewer, or differently arranged components than shown in FIGS. 1A-1B, such as one or more processors or circuits configured to perform the actions and steps described herein. As illustrated in FIG. 1A, network element 100 may include transmitter (Tx) module 110 (e.g., a Tx PIC), rotators 119, polarizers 120, polarization beam combiner (PBC) 121, PBS 140, and/or receiver (Rx) module 150 (e.g., an Rx PIC). In some implementations, transmitter module 110 may be optically connected to receiver module 150 via link 122, optical amplifiers 130, and/or PBS 140. Link 122 may include one or more optical amplifiers 130 that amplify an optical signal as the optical signal is transmitted over link 122.

Transmitter module 110 may include a number of optical transmitters 112-1 through 112-N (where N [symbol] 113, optical multiplexer 114, polarizers 120, and/or polarization beam combiner (PBC) 121. Each optical transmitter 112 may receive a data channel (TxCh1 through TxChN), modulate the data channel with an optical signal, and transmit the data channel as an optical signal. In one implementation, transmitter module 110 may include 5, 10, 20, 50, 100, or some other number of optical transmitters 112. Each optical transmitter 112 may be tuned to use an optical carrier of a designated wavelength. It may be desirable that the grid of wavelengths emitted by optical transmitters 112 conform to a known standard, such as a standard published by the Telecommunication Standardization Sector (ITU-T).

In some implementations, each of optical transmitters 112 may include a laser, a modulator, a semiconductor optical amplifier (SOA), and/or some other components. The laser, modulator, and/or SOA may be coupled with a tuning element that can be used to tune the wavelength of the optical signal channel by the laser, modulator, or SOA. In some implementations, a single laser may be shared by multiple optical transmitters 112.

Waveguides 113 may include an optical link or some other link to transmit modulated outputs (referred to as “signal channels”) of optical transmitters 112. In some implementations, each optical transmitter 112 may connect to one waveguide 113 or to multiple waveguides 113 to transmit signal channels of optical transmitters 112 to optical multiplexer 114.

Optical multiplexer 114 may include an arrayed waveguide grating (AWG) or some other multiplexing device. In some implementations, optical multiplexer 114 may combine multiple signal channels, associated with optical transmitters 112, into wave division multiplexed (WDM) signals, such as optical signals 115 and 116. In some implementations, optical multiplexer 114 may include an input, (e.g., a first slab to receive signal channels) and an output (e.g., a second slab to supply WDM signals, such as optical signals 115 and 116, associated with input signal channels). Optical multiplexer 114 may also include waveguides connecting the input and the output. In some implementations, the first slab and the second slab may each act as an input and an output. For example, the first slab and the second slab may each receive multiple signal channels. The first slab may supply a single WDM signal corresponding to the signal channels received by the second slab. The second slab may supply a single optical signal (e.g., a WDM signal) corresponding to the signal channels received by the first slab. As shown in FIG. 1A, optical multiplexer 114 may receive signal channels outputted by optical transmitters 112, and output optical signals 115 and 116. Optical signals 115 and 116 may each include one or more optical signals, such that each optical signal includes one or more wavelengths.

Rotator 119 may include an optical device or a collection of optical devices. In some implementations, rotator 119 may receive an optical signal with components having a first polarization (e.g., a TM polarization), rotate the polarization of the components, associated with the optical signal, and supply an optical signal with rotated components having a second polarization (e.g., a TE polarization). In some implementations, rotator 119 may be associated with transmitter module 110. Rotator 119 may receive components associated with optical signal 115 having a first polarization (e.g., a TM polarization), and supply optical signal 117 with rotated components having a second polarization (e.g., a TE polarization). As shown in FIG. 1A, rotator 119 may supply optical signal 117 to PBC 121.

Additionally, or alternatively, rotator 119 may be associated with receiver module 150 and may receive components associated with optical signal 116 having a first polarization (e.g., a TM polarization), and supply optical signal 118 with rotated components having a second polarization (e.g., a TE polarization). As shown in FIG. 1A, rotator 119 may supply optical signal 118 to optical demultiplexer 151.

As described above, rotator 119 may be capable of receiving multiple sets of components associated with multiple optical signals and supplying multiple sets of rotated components associated with the received components. As shown in FIG. 1A, rotator 119 may be located separate and/or detached from receiver module 150. Similarly, 119 may be located separate and/or detached from transmitter module 110.

Polarizer 120 may include an optical device, or a collection of optical devices. In some implementations, polarizer 120 may receive an optical signal, and may absorb components of the optical signal having a particular polarization such as a first polarization (e.g., a TM polarization) or a second polarization (e.g., a TE polarization). In some implementations, polarizers 120 may be associated with transmit module 110 and may receive optical signal 115 supplied by optical multiplexer 114 and/or optical signal 117 supplied by rotator 119.

In some implementations, polarizers 120 may absorb residual components of optical signal 117 having the first polarization. For example, as described above rotator 119 may rotate components associated with optical signal 115 having the first polarization, to supply optical signal 117 with components having the second polarization. Optical signal 117 may include residual components associated with the first polarization. Polarizer 120 may be connected along a path associated with optical signal 117 to absorb the residual components associated with the first polarization, thereby absorbing components having an undesirable polarization. Similarly, polarizer 120 may be connected along a path associated with optical signal 115 to absorb components having an undesirable polarization.

Additionally, or alternatively, polarizers 120 may be associated with receiver module 150 and may receive optical signal 117 supplied by PBS 140 and/or optical signal 118 supplied by rotator 119. In a similar manner as described above, polarizers 120 may absorb components of optical signal 118 having the first polarization (e.g., residual components of optical signal 118 having the first polarization when rotator 119 supplies optical signal 118). Similarly, polarizer 120 may be connected along a path associated with optical signal 117 to absorb components having an undesirable polarization.

PBC 121 may include an optical device, or a collection of optical devices. In some implementations, PBC 121 may receive multiple optical signals and supply a combined optical signal (e.g., a WDM signal, or some other type of optical signal). For example, as shown in FIG. 1A, PBC 121 may receive optical signal 116 and optical signal 117. PBC 121 may supply optical signal 125 based on receiving optical signals 116 and 117. In some implementations, optical signal 125 may include a combined WDM signal associated with optical signals 116 and/or 117.

PBS 140 may include an optical device or a collection of optical devices. In some implementations, PBS 140 may receive an input optical signal (e.g., optical signal 125 or some other signal), and supply output components associated with the input optical signal (e.g., via a first output and/or a second output of PBS 140). As shown in FIG. 1A, PBS 140 may receive optical signal 125 supplied by PBC 121 (e.g., via link 122). PBS 140 may supply components, associated with optical signal 125, (e.g., via a first output and a second output), such as components associated with optical signal 116 (referred to as “first components 116”), and/or components associated with optical signal 117 (referred to as “second components 117”). In some implementations, PBS 140 may supply first components 116 to rotator 119, and supply second components 117 to optical demultiplexer 151. First components 116 may be associated with a first polarization (e.g., a TM polarization) while second components 117 may be associated with a second polarization (e.g., a TE polarization).

As further shown in FIG. 1A, receiver module 150 may include polarizers 120, optical demultiplexer 151, waveguides 152, and/or optical receivers 153-1 through 153-O (where O [symbol] ≧1). In som AWG or some other device. Optical demultiplexer 151 may supply multiple signal channels based on receiving a WDM signal (e.g., optical signal 125), or components associated with the WDM signal. For example, optical demultiplexer 151 may include an input (e.g., a first slab region to receive second components 117, optical signal 118 (referred to as “rotated components 118”), and/or some other input component), and an output (e.g., a second slab region to supply multiple signal channels associated with the input). Optical demultiplexer 151 may include waveguides connecting the input and the output. In some implementations, the first slab and the second slab may each act as an input and an output. For example, the first slab and the second slab may each receive components associated with a WDM signal. The first slab may supply signal channels corresponding to the components received by the second slab. The second slab my supply signal channels corresponding to the components received by the first slab. As shown in FIG. 1A, optical demultiplexer 151 may supply signal channels to optical receivers 152 via waveguides 152.

Waveguides 152 may include optical links or some other links to transmit outputs of optical demultiplexer 151 to optical receivers 153. In some implementations, each optical receiver 153 may receive outputs via a single waveguide 152 or via multiple waveguides 152.

Optical receivers 153 may each operate to convert the input optical signal to an electrical signal that represents the transmitted data. In some implementations, optical receivers 153 may each include one or more photodetectors and/or related devices to receive respective input optical signals outputted by optical demultiplexer 151 and a local oscillator, convert the signals to a photocurrent, and provide a voltage output to function as an electrical signal representation of the original input signal.

In some implementations, and as shown in FIG. 1B, PBS 140 may be located on receiver module 150. As a result, transmitter module 110 may supply optical signal 125 to receiver module 150, via link 122 and/or amplifiers 130. PBS 140 may receive optical signal 125, and may supply first components 116, to rotator 119, along a first path on receiver module 150, and second components 117, to optical demultiplexer 151, along a second path on receiver module 150.

FIGS. 1C and 1D illustrates an exemplary communication method for latency based routing using a baseline approach in accordance with some examples of the disclosure. In this disclosure, latency based routing approaches are disclosed that can be used to compute signal paths in an optical communication network that is aware of the latency in various fiber segments or links of the network. Thus, these approaches use measurements or knowledge about the latency of each fiber of each segment or link. If Layer-0 fiber links latencies are measured or estimated using distances, these can be used directly as the ‘metric’ for path computations. With these metrics, the various routing techniques disclosed may compute two diverse paths (work and protect) so that the protect path can be used upon failure of the work path under normal operating conditions. One objective may be to compute work and protect paths that minimizing the differential latency between the work and protect paths. Merely to simplify the following description, the latency of each connection between a pair of network devices will be assumed to be 1 millisecond.

FIGS. 1C and 1D show a network 200 composed of a plurality of devices (e.g. nodes, switches, routers) interconnected by fiber links or segments. As shown, a network 200 may include a first device 210 connected to a second device 220 through a first connection 215 (e.g. an optical fiber, link, or segment), the second device 220 connected to a third device 230 through a second connection 225, the third device 230 connected to a fourth device 240 through a third connection 235, the fourth device 240 connected to a fifth device 250 through a fourth connection 245, the fifth device 250 connected to a sixth device 260 through a fifth connection 255, the sixth device 260 connected to the first device 210 through a sixth connection 265, the first device 210 connected to a seventh device 270 through a seventh connection 275, the seventh device 270 connected to the fourth device 240 through an eighth connection 285. While the network 200 is shown as a simplified ring structure with only seven nodes or devices, it should be understood that the network 200 may include hundreds or thousands of nodes or devices configured in many different configurations.

When a path set up request for communication between, for example, the first device 210 and the fourth device 240 is initiated. The path set up request may be initiated by a centralized device (not shown) in communication with the various devices within the network 200, a requesting device (not shown) from another network or client, or by one of the devices within the network 200 such as the first device 210. The path set up request may be for a path between a source node (e.g. the first device 210) and a destination node (e.g. the fourth device 240). With the pair of devices established for the path, the least latency of disjointed paths (work and protect) can be computed. First, for the given node pair (the first device 210 (s) and the fourth device 240 (t)), compute a set ‘S’ of all possible disjoint path pairs through the network 200 between these two nodes. In this example, Step 1 is to use a k-shortest paths algorithm (e.g. solving the NP complete problem based on the network connections) based on latencies as ‘distance’ to find successive paths of increasing latency as one of the candidate paths.

For each candidate path obtained in Step 1, Step 2 is performed. In Step 2: remove the path found in the above step and compute successive k-shortest latency paths in the residual graph. Each pair, where first path is from step 1 and second path is from a single iteration of step 2, goes into set ‘S’. Then, put back the removed path and continue to the next iteration of Step 1. Next, pick the two paths from ‘S’ that have the least differential latency between them. Last, pick the path with lower (absolute) latency as the work path from the source node to the destination node.

For example, assuming each connection or link has equal latency in FIGS. 1C and 1D.

Then, set S will contain the following unique pairs:

P1: s-e-t the first step using the network of FIG. 1C is to find the shortest path. This will be s-e-t. As shown in FIG. 1D, this path (s-e-t) is removed leaving a residual graph/network as shown.

P2: s-a-b-t is revealed as a candidate path

P1: s-e-t starting the first step again

P2: s-d-c-t is revealed as a candidate path

P1: s-a-b-t starting the first step again without s-e-t

P2: s-d-c-t is revealed as a candidate path.

The last pair will be picked since the last pair has matching latency or a differential latency of zero. This is a brute-force search for the optimum with several drawbacks. For instance, the complexity of evaluating the solution as described here could take exponential time based on the size of the input/network and difficult to implement for practical applications.

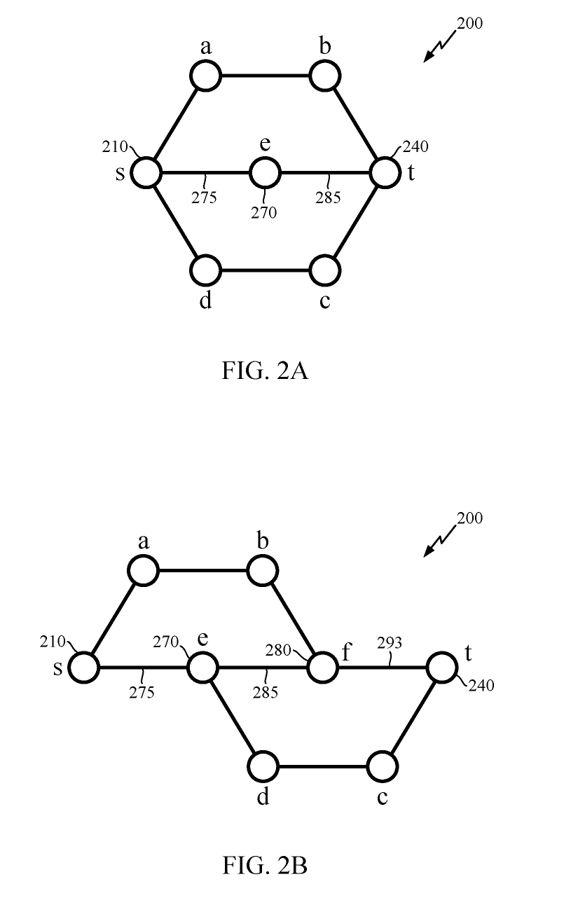

FIGS. 2A and 2B illustrates an exemplary communication method for latency based routing using a least latency approach in accordance with some examples of the disclosure. As shown in FIG. 2A, a least latency path through network 200 from the first device 210 to the fourth device 240 is determined. In this case, the first path (e.g. work path) is determined to be from the first device 210 through the seventh connection 275 to the seventh node 270, then from the seventh node 270 through the eighth connection 285 to the fourth node 240. The determined first path will be the least latency work path. Now, a second path through the network 200 is determined that is diverse from the first path and also has the least possible latency. First, the work or first path is removed and the least latency path remaining in the network is determined. However, you may not always be able to find the second/protect path using this approach. This approach may be useful when protection path quality is not a high priority and the work path needs to be the best possible. In this approach, the complexity is given as O(E+V log V)+O(V)+O(E+V log V), which is O(E+V log V), where O is the computational complexity, V is # vertices, and E is #edges in the network/graph.

For example, FIG. 2B shows a network 200 configuration that includes an eighth device 280 connected as shown. In this network configuration, there could be cases where a fully diverse protect path may not exist if a least latency path is picked as one of the working/protect paths. For example, if the least latency determines the first path as the first device 210 through the seventh connection 275 to the seventh device 270, then through the eighth connection 285 to the eighth device 280, and then through a ninth connection 293 to the fourth device 240. Once this first path is set as the work path, then the configuration of the network 200 would prevent finding a second path with complete diversity from the first path. Thus, a fully diverse protect path does not exist when the least latency path is picked as the work path.

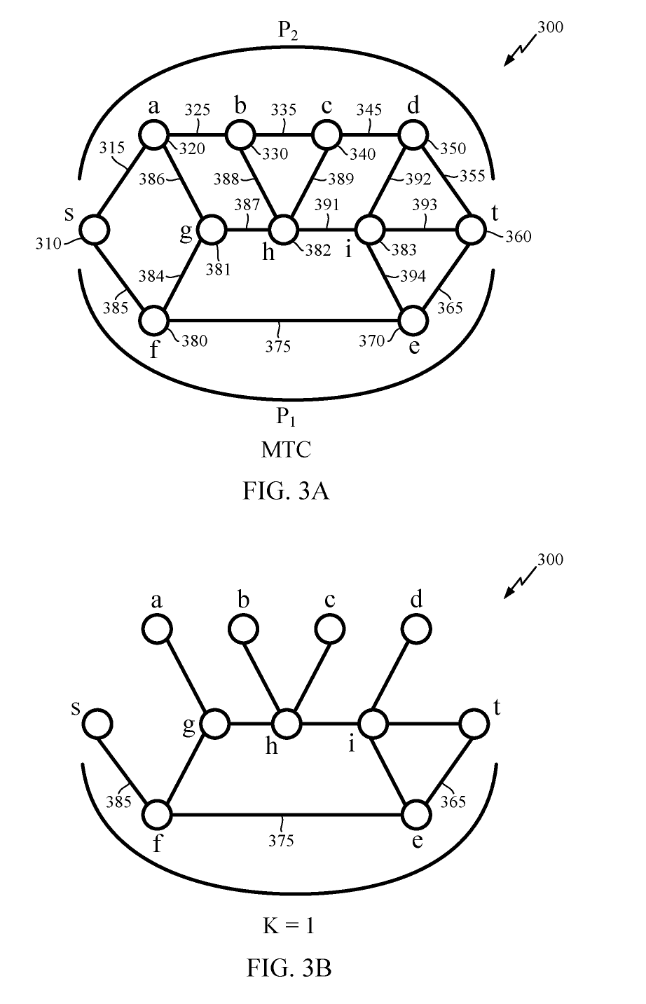

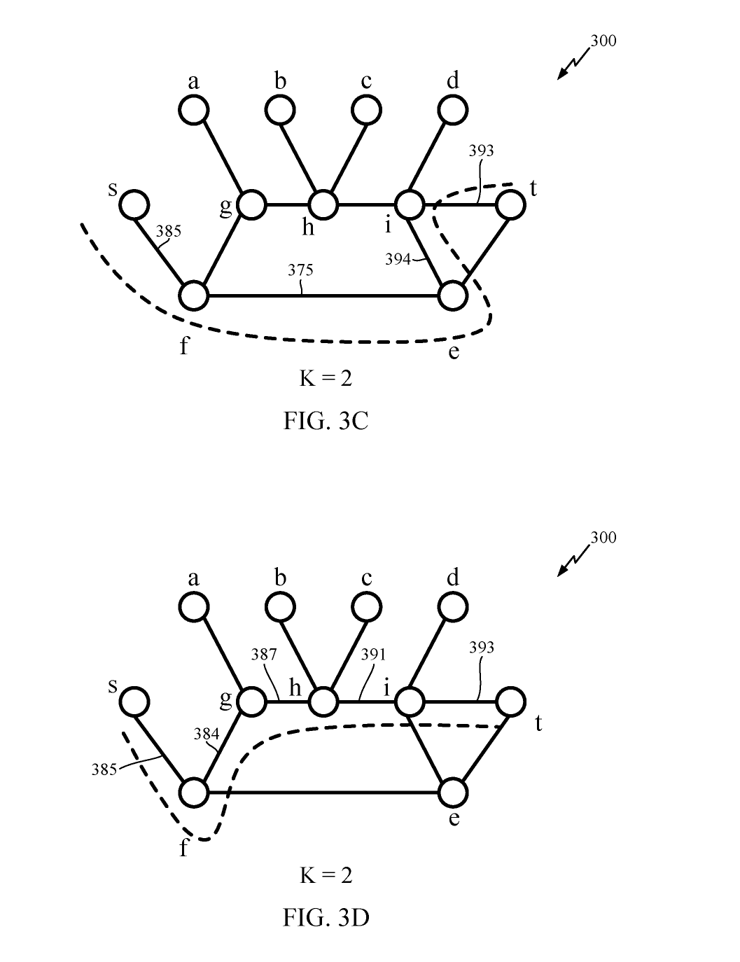

FIGS. 3A-D illustrates an exemplary communication method for latency based routing using a shortest path solution pair approach in accordance with some examples of the disclosure. As shown, a network 300 may include a first device 310 connected to a second device 320 through a first connection 315 (e.g. an optical fiber, link, or segment), the second device 320 connected to a third device 330 through a second connection 325, the third device 330 connected to a fourth device 340 through a third connection 335, the fourth device 340 connected to a fifth device 350 through a fourth connection 345, the fifth device 350 connected to a sixth device 360 through a fifth connection 355, the sixth device 360 connected to a seventh device 370 through a sixth connection 365, the seventh device 370 connected to an eighth device 380 through a seventh connection 375, the eighth device 380 connected to the first device 310 through an eighth connection 385 and connected to a ninth device 381 through a ninth connection 384, the ninth device is connected to the second device 320 through a tenth connection 386 and a tenth device 382 through an eleventh connection 387, the tenth device 382 is connected to the third device 330 through a twelfth connection 388 and the fourth device through a thirteenth connection 389 and an eleventh device 383 through a fourteenth connection 391, the eleventh device 383 is connected to fifth device 350 through a fifteenth connection 392 and to the sixth device 360 through a sixteenth connection 393 and to the seventh device 370 through a seventeenth connection 394.

In this example, the topology of the network 300 including the connections of each of the devices in the network and the latency information is first retrieved. Then, the determination starts with computing a minimum-total cycle (MTC) for the first device 310 and seventh device 370 [s,t] pair. The MTC may be calculated using, for example, Dijkstra's shortest path computation, the Floyd-Warshall algorithm, or similar approach. This gives two paths P1, P2 as shown in FIG. 3A. Using the assumption that each connection has a latency of 1 millisecond, P1 has a latency of 3 ms (connection 385, connection 375, and connection 365) and P2 has a latency of 5 ms (connection 315, connection 325, connection 335, connection 345, and connection 355) with a differential latency of 2 ms (5 ms−3 ms).

Remove the longer path P2 from the graph, which results in the graph shown in FIG. 3B. Using the configuration of FIG. 3B, k-shortest paths (KSP) on residual graph are computed until a stopping condition is reached. One example of a stopping condition is if the current KSP latency equals the removed path latency for a differential latency of the solution pair being equal to zero. FIG. 3B shows a first iteration where the path has a 3 ms latency (connection 385, connection 375, and connection 365) that results in a differential latency of 2 ms (5 ms−3 ms). This is the same as P1 and may be skipped if desired and configured to remove this path from KSP calculations after P2 is selected. FIG. 3C shows a second iteration where the path has a 4 ms latency (connection 385, connection 375, connection 394, and connection 393) for a differential latency of 1 ms. FIG. 3D shows a third iteration where the path has a 5 ms latency (connection 385, connection 384, connection 387, connection 391, and connection 393) for a differential latency of 0 ms. Since we found a path that has a latency at least as much as that of P2, is sufficient to stop the process (iterating) at this time. A zero differential latency is the lowest possible and there is no need to continue unless alternative paths are desired. For instance, if the last two successive paths prior to termination of the previous step are Py, Pz and if the latency of Pz matches P2 exactly, we pick [P2,Pz] as the solution pair. Otherwise, min(|Py−P2|, |Pz−P2|) is used to decide whether Py or Pz is the other path besides P2 to make up the solution pair. Finally, a work path is selected based on the absolute lower latency in the solution pair.

The KSP on the residual graph is guaranteed to start with a path at least as expensive as P1 due to the MTC process that determined P1 and P2. Therefore, it is not necessary iterating over shorter paths to reach a stage that weighs as much as P1 (which is a solution we already have). This gives a lower bound on the solution at Dijkstra's (shortest path computation) complexity, which may be very close to the next solution if the min-total cycle spans a cut-set of the graph. P2 is selected as one of the final paths and the iterative approach starts finding candidates for a solution pair with P2. The other path is guaranteed to be diverse from P2 and with latency just below or just above P2 or equal to that of P2. Additionally, heuristic may be employed during the iterations to cap the process based on a number of iterations, solution quality, gap etc. In this example, the complexity is: O(E+E log V)+O(V)+O(KV(E+V log V)) where K is the number of iterations spent on the residual graph. First part is the MTC computation time, second term is the path removal time and the third term is the KSP computation time on the residual graph.

Another example of a heuristic approach searches for bottle necks in the solutions. For example, U.S. Pat. No 8,891,360, expressly incorporated by reference in its entirety details an umbrella algorithm for use in a shared mesh network. The approach detailed therein may be modified to have an objective of lowering latency differentials. First, an auxiliary graph is constructed (not shown) by assigning a weight on every link/connection that corresponds to the latency differential of that protect path with respect to the work path. Next, the ‘narrowest’ path in the auxiliary graph is computed. This may be done in real time by computing a minimum spanning tree (MST) and determining paths from source node (s) to destination node (t).

This minimizes the maximum differential latency among the candidate solutions that the umbrella algorithm considers. Finally, the narrowest path on the auxiliary is evaluated to pick protect paths (each link in auxiliary corresponds to one protect path. Optionally, paths that backtrack on the auxiliary graph from ‘s’ to ‘t’ may be pruned since coverage of the shared risk link groups (SRLGs) is guaranteed when these are removed from consideration. For this approach, the complexity analysis indicates that if the working path has ‘m’ hops, then umbrella has mC2 iterations of Dijkstra. Additionally, to meet the differential latency objective, the processing required is to build auxuliary based on the differential latencies that takes O(V) per path and mC2O(V) in the worst case. Another O(m) may be used to evaluate the MST to get the narrowest path. So, total time is mC2×O(E+V log V)+mC2O(V)+O(m) where m can be V in the worst case and V is the number of vertices in the graph.

The heuristics described herein may be used in a network planning system, such as Infinera's NPS, to compute differential latency optimized paths during network planning for example. This would give an estimate of the resources and equipment required to support these features for a subset/all of the services that need to be planned. The same system can also employ these heuristics to do a what-if/failure analysis by choosing this differential latency feature for some services. The heuristics may also be used in a network element such as Infinera's DTN-X, an L2 device or a L3 device like a router, or a centralized software defined network (SDN) controller. For any network element or processing entity that is aware of network topology, the resources in use can use these heuristics to compute paths that are optimized for achieving differential latency for a service to be provisioned. As an example, they may be used to set up 1+1 dedicated protection paths. The heuristics may also be used to compute Infinera Fast SMP paths provided sharing bandwidth is also accounted for as part of the process. In addition, the heuristics may be employed at a higher layer. If it is required at the higher layers (beside the fiber or physical layer), for example, the OTN (L1) layer or the packet (L2/L3) layer. Then, the work and protect paths may need to be SRLG diverse in addition to having minimum differential latency to avoid underlying single failures such as a fiber cut. In cut fiber cases, the extensions need to be used to achieve the same or similar results. Alternatively, if diversity is required only within a layer, then the heuristics as described may be used without changes.

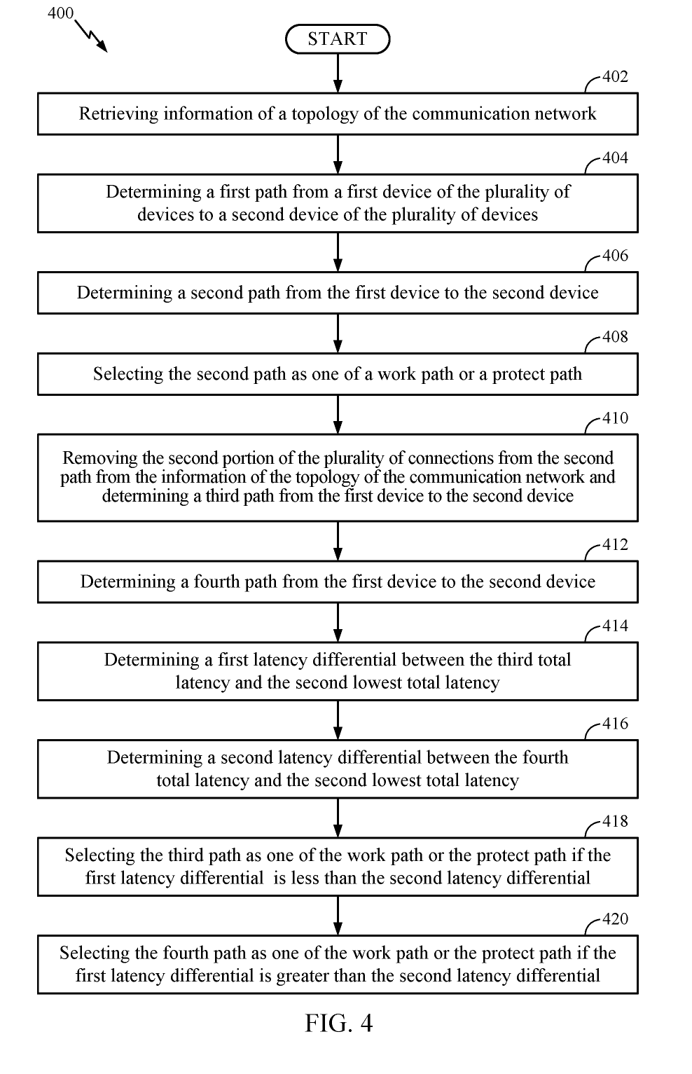

FIG. 4 illustrates an exemplary communication method for latency based routing using a baseline approach in accordance with some examples of the disclosure. The partial process begins in step 402 with retrieving information of a topology of the communication network, the information including a plurality of connections between each of a plurality of devices in the communication network and latency information of each connection of the plurality of connections. Next in step 404, the partial process continues with determining a first path from a first device of the plurality of devices to a second device of the plurality of devices, the first path including a first portion of the plurality of connections with a lowest total latency between the first device and the second device. Next in step 406, the partial process continues with determining a second path from the first device to the second device, the second path including a second portion of the plurality of connections with a second lowest total latency between the first device and the second device. Next in step 408, the partial process continues with selecting the second path as one of a work path or a protect path. Next in step 410, the partial process continues with removing the second portion of the plurality of connections from the second path from the information of the topology of the communication network and determining a third path from the first device to the second device, the third path including a third portion of the plurality of connections with a third total latency between the first device and the second device Next in step 412, the partial process continues with determining a fourth path from the first device to the second device, the fourth path including a fourth portion of the plurality of connections with a fourth total latency between the first device and the second device. Next in step 414, the partial process continues with determining a first latency differential between the third total latency and the second lowest total latency. Next in step 416, the partial process continues with determining a second latency differential between the fourth total latency and the second lowest total latency. Next in step 418, the partial process continues with selecting the third path as one of the work path or the protect path if the first latency differential is less than the second latency differential. Next in step 420, the partial process concludes with selecting the fourth path as one of the work path or the protect path if the first latency differential is greater than the second latency differential.

In any process by which a stream of data is partitioned across multiple connections, it is important to control the differential latency between the connections, such as working and protection paths for example. If there is a very high differential latency between two connections in an aggregate group, then reconstituting the original stream can require a great deal of memory at the receiver, and it can add latency to the traffic flow. This leads to a costly and poor overall solution. The differential latency between two pairs is affected by a number of factors, including the line rate of each line and the effective transmission distance of each line of the pair. For example, Ethernet bonding places a restriction on the amount of differential latency that can be tolerated in an aggregate group. Examples of use cases for latency based routing include latency sensitive applications (e.g. stock trading, online gaming, video conferencing), applications that may have real-time requirements, and differential latency sensitive applications that are susceptible to failures (e.g. machine-to-machine interactions, video on demand, load balancing applications). It may not be critical to achieve least latency on a given path in these applications but it might be critical to achieve least possible differential latency between working and protection paths. These may include objectives such as: latency optimized work path, and a protection path that is diverse for latency sensitive applications or differential latency optimized [work+protect] path pair for differential latency sensitive applications.

Examples of extensions to the heuristics described above may be used with shared risks that could be user configured, reconfigurable optical add drop multiplexers (ROADMs), optical expresses etc. For example, to compute a SRLG disjoint path pair, a first heuristic may be used such as NP-complete by itself. Then, the process may process several iterations to get the best total cost for the solution path. Next, the heuristic described with reference to FIGS. 3A-D may be employed to close the latency gap in the two disjoint path solutions. Additionally, the longer path must be removed before running KSP, but also the SRLG's associated with the longer path. Removing a path from consideration may be done in a number of ways. One way is to remove the links of the path, which can be used if the diversity required is link or fiber diversity. A second way involves removing nodes and links of the path, which can be used if node diversity is required. Similarly, MTC may be link or node diverse min-total cycle depending on the requirement.

Examples of the network devices mentioned above (e.g. devices 210-280) may include routers or switches, such as Infinera's DTN-X platform, that may have multiple functionalities like L0 wavelength division multiplexing (WDM) transport capabilities, L1 digital OTN switching capabilities, and L2 packet switching capabilities. The network 100 may be optimized by enabling the packet switching feature in network devices using protocols such as MPLS-TP and switching LSP's, and packet switching in the network core can be performed by the devices.

The word “exemplary” is used herein to mean “serving as an example, instance, or illustration.” Any details described herein as “exemplary” is not necessarily to be construed as preferred or advantageous over other examples. Likewise, the term “examples” does not require that all examples include the discussed feature, advantage or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples only and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, step, feature, benefit, advantage, or equivalent to the public, regardless of whether the component, step, feature, benefit, advantage, or the equivalent is recited in the claims.

Further, those of skill in the art will appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method step or as a feature of a method step. Analogously thereto, aspects described in connection with or as a method step also constitute a description of a corresponding block or detail or feature of a corresponding device. Some or all of the method steps can be performed by a hardware apparatus (or using a hardware apparatus), such as, for example, a microprocessor, a programmable computer or an electronic circuit. In some examples, some or a plurality of the most important method steps can be performed by such an apparatus.

In the detailed description above it can be seen that different features are grouped together in examples. This manner of disclosure should not be understood as an intention that the claimed examples require more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods disclosed in the description or in the claims can be implemented by a device comprising means for performing the respective steps or actions of this method.

Furthermore, in some examples, an individual step/action can be subdivided into a plurality of sub-steps or contain a plurality of sub-steps. Such sub-steps can be contained in the disclosure of the individual step and be part of the disclosure of the individual step.

While the foregoing disclosure shows illustrative examples of the disclosure, it should be noted that various changes and modifications could be made herein without departing from the scope of the disclosure as defined by the appended claims. The functions, steps and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method for routing signals in a communication network, the method comprising:
retrieving information of a topology of the communication network, the information including a plurality of connections between each of a plurality of devices in the communication network and latency information of each connection of the plurality of connections;
determining a first path from a first device of the plurality of devices to a second device of the plurality of devices, the first path including a first portion of the plurality of connections with a lowest total latency between the first device and the second device;
determining a second path from the first device to the second device, the second path including a second portion of the plurality of connections with a second lowest total latency between the first device and the second device;
selecting the second path as one of a work path or a protect path;
removing the second portion of the plurality of connections from the second path from the information of the topology of the communication network;
determining a third path from the first device to the second device, the third path including a third portion of the plurality of connections with a third total latency between the first device and the second device;
determining a fourth path from the first device to the second device, the fourth path including a fourth portion of the plurality of connections with a fourth total latency between the first device and the second device;
determining a first latency differential between the third total latency and the second lowest total latency;
determining a second latency differential between the fourth total latency and the second lowest total latency;
selecting the third path as one of the work path or the protect path if the first latency differential is less than the second latency differential; and
selecting the fourth path as one of the work path or the protect path if the first latency differential is greater than the second latency differential.

2. The method for routing signals of claim 1, further comprising selecting the second path as the work path if the second lowest total latency is less than the third total latency when the third path is selected or if the second lowest total latency is less than the fourth total latency when the fourth path is selected.

3. The method for routing signals of claim 2, further comprising selecting the second path as the protect path if the second lowest total latency is greater than the third total latency when the third path is selected or if the second lowest total latency is greater than the fourth total latency when the fourth path is selected.

4. The method for routing signals of claim 1, further comprising measuring a latency for at least a portion of the plurality of connections and updating the latency information based on the measured latency.

5. The method for routing signals of claim 1, wherein the third path is disjoint from the second path such that no connection of the third path is the same as any connection of the second path.

6. The method for routing signals of claim 5, wherein the fourth path is disjoint from the second path such that no connection of the fourth path is the same as any connection of the second path.

7. The method for routing signals of claim 1, further comprising determining additional paths and associated latencies until one of the additional paths and the associated latencies equals the second lowest total latency.

8. The method for routing signals of claim 1, further comprising determining additional paths and associated latencies until a predetermined number of paths have been determined.

9. An apparatus comprising:
a first circuit configured to retrieve information of a topology of the communication network, the information including a plurality of connections between each of a plurality of devices in the communication network and latency information of each connection of the plurality of connections;
the first circuit configured to determine a first path from a first device of the plurality of devices to a second device of the plurality of devices, the first path including a first portion of the plurality of connections with a lowest total latency between the first device and the second device;
the first circuit configured to determine a second path from the first device to the second device, the second path including a second portion of the plurality of connections with a second lowest total latency between the first device and the second device;
the first circuit configured to select the second path as one of a work path or a protect path;
the first circuit configured to remove the second portion of the plurality of connections from the second path from the information of the topology of the communication network;
the first circuit configured to determine a third path from the first device to the second device, the third path including a third portion of the plurality of connections with a third total latency between the first device and the second device;
the first circuit configured to determine a fourth path from the first device to the second device, the fourth path including a fourth portion of the plurality of connections with a fourth total latency between the first device and the second device;
the first circuit configured to determine a first latency differential between the third total latency and the second lowest total latency;
the first circuit configured to determine a second latency differential between the fourth total latency and the second lowest total latency;
the first circuit configured to select the third path as one of the work path or the protect path if the first latency differential is less than the second latency differential; and
the first circuit configured to select the fourth path as one of the work path or the protect path if the first latency differential is greater than the second latency differential.

10. The apparatus of claim 9, further comprising the first circuit configured to select the second path as the work path if the second lowest total latency is less than the third total latency when the third path is selected or if the second lowest total latency is less than the fourth total latency when the fourth path is selected.

11. The apparatus of claim 10, further comprising the first circuit configured to select the second path as the protect path if the second lowest total latency is greater than the third total latency when the third path is selected or if the second lowest total latency is greater than the fourth total latency when the fourth path is selected.

12. The apparatus of claim 9, further comprising the first circuit configured to measure a latency for at least a portion of the plurality of connections and updating the latency information based on the measured latency.

13. The apparatus of claim 9, wherein the third path is disjoint from the second path such that no connection of the third path is the same as any connection of the second path.

14. The apparatus of claim 13, wherein the fourth path is disjoint from the second path such that no connection of the fourth path is the same as any connection of the second path.

15. The apparatus of claim 9, further comprising the first circuit configured to determine additional paths and associated latencies until one of the additional paths and the associated latencies equals the second lowest total latency.

16. The apparatus of claim 9, further comprising the first circuit configured to determine additional paths and associated latencies until a predetermined number of paths have been determined.

17. A non-transient computer readable medium containing program instructions for causing a processor to perform a process comprising:
retrieving information of a topology of the communication network, the information including a plurality of connections between each of a plurality of devices in the communication network and latency information of each connection of the plurality of connections;
determining a first path from a first device of the plurality of devices to a second device of the plurality of devices, the first path including a first portion of the plurality of connections with a lowest total latency between the first device and the second device;
determining a second path from the first device to the second device, the second path including a second portion of the plurality of connections with a second lowest total latency between the first device and the second device;
selecting the second path as one of a work path or a protect path;
removing the second portion of the plurality of connections from the second path from the information of the topology of the communication network;
determining a third path from the first device to the second device, the third path including a third portion of the plurality of connections with a third total latency between the first device and the second device;
determining a fourth path from the first device to the second device, the fourth path including a fourth portion of the plurality of connections with a fourth total latency between the first device and the second device;
determining a first latency differential between the third total latency and the second lowest total latency;
determining a second latency differential between the fourth total latency and the second lowest total latency;
selecting the third path as one of the work path or the protect path if the first latency differential is less than the second latency differential; and
selecting the fourth path as one of the work path or the protect path if the first latency differential is greater than the second latency differential.

18. The non-transient computer readable medium of claim 17, the process further comprising selecting the second path as the work path if the second lowest total latency is less than the third total latency when the third path is selected or if the second lowest total latency is less than the fourth total latency when the fourth path is selected.

19. The non-transient computer readable medium of claim 17, the process further comprising selecting the second path as the protect path if the second lowest total latency is greater than the third total latency when the third path is selected or if the second lowest total latency is greater than the fourth total latency when the fourth path is selected.

20. The non-transient computer readable medium of claim 17, the process further comprising measuring a latency for at least a portion of the plurality of connections and updating the latency information based on the measured latency.
